(19) United States
(12) Patent Application Publication
(10) Pub. No.: US 2025/0145026 A1
(43) Pub. Date: May 8, 2025

(54) MULTIFUNCTIONAL UNIFIED STRUCTURE THERMAL PLATE

(71) Applicant: GM Global Technology Operations LLC, Detroit, MI (US)

(72) Inventors: Joel S. Hooton, Chesterfield, MI (US); Joshua L. Solomon, Berkley, MI (US); Hui-Ping Wang, Troy, MI (US); Lu Huang, Troy, MI (US); Xiaoling Chen, Sterling Heights, MI (US)

(73) Assignee: GM GLOBAL TECHNOLOGY OPERATIONS LLC, Detroit, MI (US)

(21) Appl. No.: 18/502,146

(22) Filed: Nov. 6, 2023

(51) Int. Cl. B60L 50/64; H01M 10/613; H01M 10/625; H01M 10/6556

(52) U.S. Cl. CPC B60L 50/64; H01M 10/613; H01M 10/625; H01M 10/6556; H01M 2220/20

(57) ABSTRACT

A multifunctional unified structure thermal plate and system for supporting a plurality of battery cells included as part of a high voltage battery pack. The plate may include a bottom plate and a plurality of crossbeams configured for supporting the battery cells, with the bottom plate and the crossbeams together being from as a monolithic, one-piece structure.

### INTRODUCTION

The present disclosure relates to a multifunctional unified structure thermal plate, such as but not necessarily limited to a thermal plate system configured for supporting battery cells included as part of a battery pack.

A vehicle may include an electric motor for converting electrical power to mechanical power for purposes of utilizing the mechanical power to perform work, such as to mechanically power a drivetrain to propel the vehicle. Such vehicles may include a battery pack for storing and supplying electrical power for the electric motor, with the battery packs typically including a battery enclosure of some form for enclosing a plurality of battery cells, usually with the battery cells arranged to form one or more battery modules. In the past, the battery enclosures have included a multi-piece, fragmented, or non-monolithic construction whereby a battery tray may be welded, fixed, or otherwise attached to a plurality of dividers for purposes of supporting rows or groupings of the battery cells. Such a multi-piece construction may be disadvantageous due to the welding processes required to connect the tray, dividers, and optionally additional components generally requiring larger sized components to accommodate a welding material, labor intensive and time consuming processes for individual welding each component together, and the welds tending to have limited capabilities for maximally sealing off the battery cells from each other and/or an exterior environment.

### SUMMARY

One non-limiting aspect of the present disclosure relates to a multifunctional unified structure thermal plate system for supporting a plurality of battery cells included as part of a high voltage battery pack. The thermal plate system may include a monolithic, one-piece structure operable for thermally conducting heat away from and physically supporting the battery cells. The monolithic, one-piece structure may include a bottom plate and a plurality of crossbeams formed as part of an extrusion process such that the bottom plate and the crossbeams may be a unified formation provided without welding or other labor intensive and time consuming processes and with the monolithic, one-piece structure effectively and maximally sealing off a lower portion of battery channels between the crossbeams so as to at least partially seal off the battery cells from each other and/or an exterior environment.

One non-limiting aspect of the present disclosure relates to a multifunctional unified structure thermal plate system for supporting a plurality of battery cells included as part of a high voltage battery pack. The system may include a bottom plate configured for supporting a bottom surface of one or more of the battery cells with the bottom plate shaped relative to a longitudinal axis, a width axis, and a height axis. The system may further include a plurality of crossbeams configured for supporting a side of one or more of the battery cells, wherein the crossbeams are intermittently spaced along an upper surface of the bottom plate relative to the longitudinal axis and shaped to project widthwise across the upper surface relative to the width axis and heightwise upwardly from the upper surface relative to the height axis. The bottom plate and the crossbeams may together form a monolithic, one-piece structure operable for thermally conducting heat away from and physically supporting the battery cells.

The bottom plate may include a plurality of apertures formed below the upper surface within an interior cavity with the apertures operable for circulating coolant to facilitate thermally conducting heat away from the battery cells.

The system may include a plurality of spring clips disposed between corresponding ones of the crossbeams and the battery cells with the spring clips configured for elastically pressing against the corresponding ones of the battery cells.

The spring clips may be configured for pre-compressing the battery cells during installation and accommodating cell battery cell expansion during service.

The spring clips may include a convex shape configured for flattening in response to expansion of the battery cells corresponding therewith.

The system may include a thermally conductive material applied to the crossbeams with the thermally conductive material operable to facilitate thermally enhancing heat transfer between the battery cells and the crossbeams.

The crossbeams may include a substantially planar shape, wave shape, and/or hour-glass shape.

The system may include one or more opposed longitudinal ends of the bottom plate may be shaped to include an interlock operable for connecting with an interlock of another bottom plate or a sidewall of a battery tray.

The system may include a pair of sidewalls adhered to opposed lateral sides of the bottom plate and corresponding ones of the crossbeams with the sidewalls defining battery cell channels between adjoining one of the corresponding crossbeams.

The sidewalls may be adhered to the crossbeams and the bottom plate such that a lower portion of each battery cell channel is sealed relative to the lower portion of the adjoining battery cell channel.

The sidewalls may include a plurality of through-holes aligned with a plurality of apertures formed within an interior cavity of the bottom plates.

The system acc may include a cold plate configured for supporting lower surfaces of the bottom plate and the sidewalls.

The monolithic, one-piece structure may be formed as part of an extrusion process.

One non-limiting aspect of the present disclosure relates to a battery pack for a vehicle. The battery pack may include a monolithic multifunctional unified structure thermal plate having a plurality of crossbeams intermittently spaced along a bottom plate with the crossbeams shaped to extend widthwise across the bottom plate and upwardly away from the bottom plate, and a plurality of battery cells disposed between the crossbeams such that a bottom of the battery cells is supported upon the bottom plate and opposed sides of the battery are supported by adjoining pairs of the crossbeams.

The battery pack may include a plurality of spring clips disposed between the crossbeams and the battery cells with the spring clips having a convex shape configured for elastically pressing against the corresponding ones of the battery cells such that the spring clips pre-compress the battery cells during installation and accommodate cell battery cell expansion during service.

The bottom plate may include a plurality of apertures formed within an interior cavity with the apertures being operable for circulating coolant to facilitate thermally conducting heat away from the battery cells.

One non-limiting aspect of the present disclosure relates to a vehicle. The vehicle may include a monolithic multifunctional unified structure thermal plate having a plurality of crossbeams intermittently spaced along a bottom plate with the crossbeams shaped to extend widthwise across the bottom plate and upwardly away from the bottom plate. The vehicle may further include a plurality of battery cells configured for storing and supplying electrical power with the battery cells disposed between the crossbeams such that a bottom of the battery cells is supported upon the bottom plate and opposed sides of the battery are supported by adjoining pairs of the crossbeams. The vehicle may further include an electric motor operable for generating mechanical power suitable for propelling the vehicle in response to electrical power provided from the battery cells.

The vehicle may include a plurality of spring clips disposed between the crossbeams and the battery cells with the spring clips having a convex shape configured for elastically pressing against the corresponding ones of the battery cells such that the spring clips pre-compress the battery cells during installation and accommodate cell battery cell expansion during service.

The vehicle may include a thermally conductive material applied to the crossbeams with the thermally conductive material operable to facilitate thermally enhancing heat transfer between the battery cells and the crossbeams.

The vehicle may include a coolant system configured for circulating a coolant through a plurality of apertures formed within an interior cavity of the bottom plate with the coolant system including a cold plate disposed relative to the bottom plate to facilitate dissipating heat from the bottom plate.

These features and advantages, along with other features and advantages of the present teachings, may be readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which may be incorporated into and constitute a part of this specification, illustrate implementations of the disclosure and together with the description, serve to explain the principles of the disclosure.

FIG. 1 illustrates a schematic view of a vehicle in accordance with one non-limiting aspect of the present disclosure.

FIG. 2 illustrates a partial assembly view of a battery pack in accordance with one non-limiting aspect of the present disclosure.

FIG. 3 illustrates a partial side view of a multifunctional unified structure thermal plate in accordance with one non-limiting aspect of the present disclosure.

FIG. 4 illustrates a partial side view of battery cells disposed within the multifunctional unified structure thermal plate in accordance with one non-limiting aspect of the present disclosure.

FIG. 5 illustrates a partial perspective view of the multifunctional unified structure thermal plate in accordance with one non-limiting aspect of the present disclosure.

FIG. 6 illustrates a partial perspective view of the battery cells disposed within the multifunctional unified structure thermal plate in accordance with one non-limiting aspect of the present disclosure.

FIG. 7 illustrates a partial perspective view of the multifunctional unified structure thermal plate segmented in accordance with one non-limiting aspect of the present disclosure.

FIG. 8 illustrates a partial perspective view of the multifunctional unified structure thermal plate having wave shaped crossbeams in accordance with one non-limiting aspect of the present disclosure.

### DETAILED DESCRIPTION

As required, detailed embodiments of the present disclosure may be disclosed herein; however, it may be understood that the disclosed embodiments may be merely exemplary of the disclosure that may be embodied in various and alternative forms. The figures may not be necessarily to scale; some features may be exaggerated or minimized to show details of particular components. Therefore, specific structural and functional details disclosed herein may need not to be interpreted as limiting, but merely as a representative basis for teaching one skilled in the art to variously employ the present disclosure.

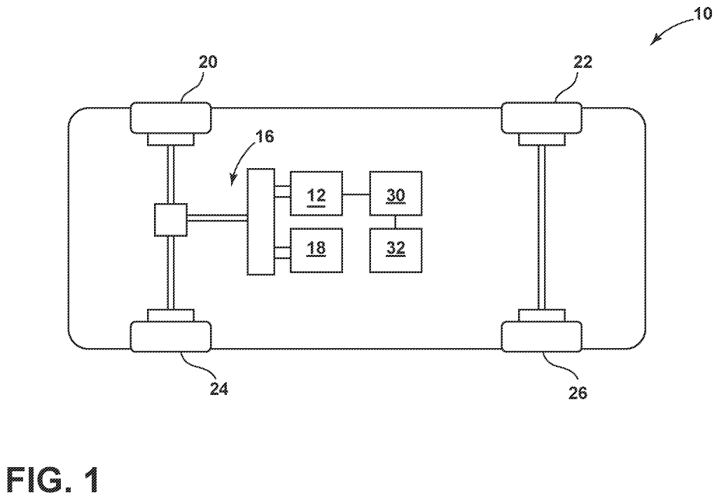

FIG. 1 illustrates a schematic view of a vehicle 10 in accordance with one non-limiting aspect of the present disclosure. The vehicle 10, which may be interchangeable referred to as an electric or hybrid vehicle 10, may include an electric motor 12 operable for converting electrical power to mechanical power for purposes of utilizing the mechanical power to perform work, such as to mechanically power a drivetrain to propel the vehicle. The vehicle 10 is illustrated as a hybrid type due to the powertrain 16 optionally including an internal combustion engine (ICE) 18 for generating mechanical power. The powertrain 16 may include a transmission, a driveshaft, a differential, axles and/or other componentry to facilitate conveying rotative force from a rotor shaft coupled with a rotor to one or more of the wheels 20, 22, 24, 26. The vehicle 10 may include a battery pack 30 for storing and supplying electrical power for the electric motor 12 and/or other system, buses, etc. onboard the vehicle 10. The vehicle 10 may include a battery monitoring system or controller 32 to facilitate monitoring, controlling, measuring, and otherwise directing operation, performance, etc. of the battery pack 30. The battery pack 30 may be mounted or affixed to a chassis or other structure within the vehicle 10, with one common implementation including the battery pack 30 being disposed beneath a floorboard and shaped and sized such that the battery pack 30 extends fore and aft relative to a front and a rear of the vehicle and laterally from a driver side to a passenger side.

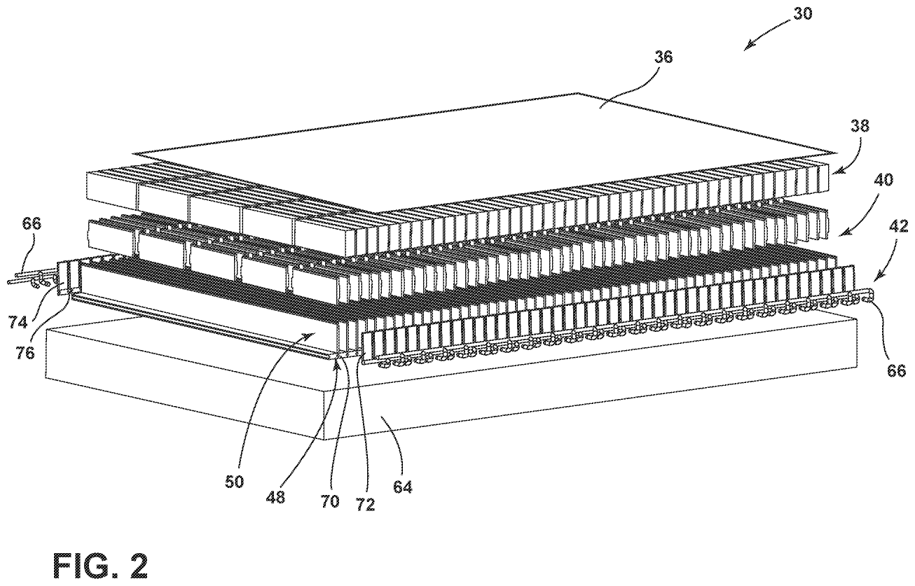

FIG. 2 illustrates an assembly view of the battery pack 30 in accordance with one non-limiting aspect of the present disclosure. The battery pack 30 may include a lid 36, a plurality of battery cells 38, a multifunctional unified structure thermal (MUST) plate system 40, and a cooling system 42. The present disclosure contemplates the battery pack 30 including a wide variety of components in addition to or in place of those described herein to facilitate placement and use within the vehicle 10 and/or within other types of devices besides vehicles. The individual components of the battery pack 30 described herein are non-limiting and intended to be merely representative of a type of battery pack 30 that may benefit from incorporation of the MUST plate system 40. In other words, the componentry presented as cooperating with the MUST plate system 40 are merely illustrative of items, parts, modules, etc. that may cooperate with the MUST plate system 40 and are not intended to limit the scope and contemplation of the present disclosure. The MUST plate system 40, which may be interchangeably referred to as a thermal plate system 40, may include a monolithic, one-piece structure operable for thermally conducting heat away from and physically supporting the battery cells 38.

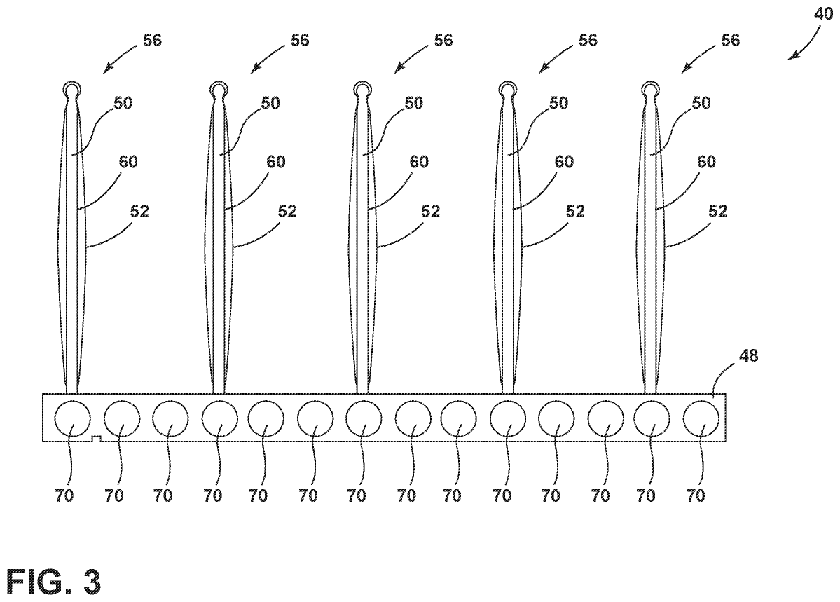

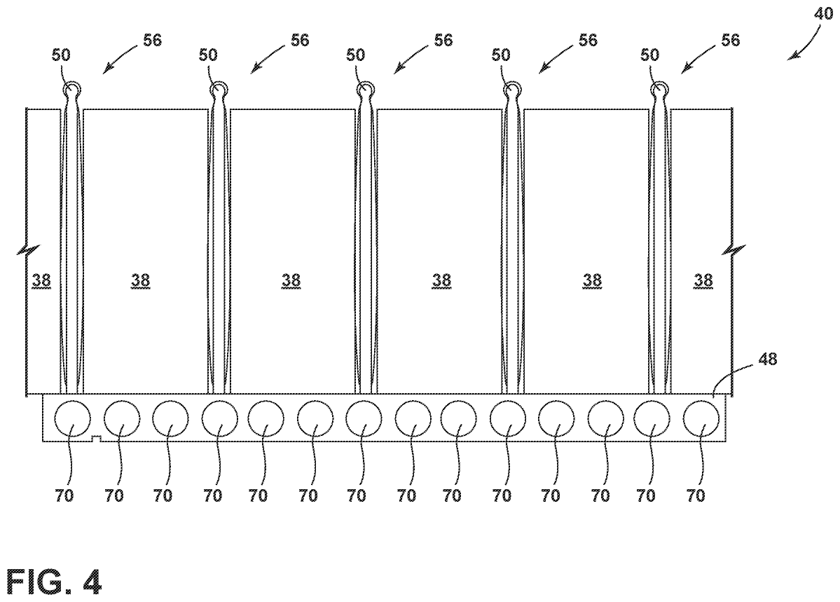

The monolithic, one-piece structure may include a bottom plate 48 and a plurality of crossbeams 50 formed as part of an extrusion process such that the bottom plate 48 and the crossbeams 50 may be a unified formation provided without welding or other labor intensive and time consuming processes and with the monolithic, one-piece structure effectively and maximally sealing off at least a lower portion between the crossbeams 50 so as to at least partially seal off the battery cells 38 from each other and/or an exterior environment. The bottom plate 48 and the crossbeams 50 may be shown in more detail in FIG. 3 where a side view of a portion of the MUST plate system 40 is shown in accordance with one non-limiting aspect of the present disclosure. As also shown, the MUST plate system 40 may optionally or additionally include a plurality of spring clips 52 attached to the crossbeams 50. The spring clips 52 may be disposed between corresponding ones of the crossbeams 50 and the battery cells 38 and configured for elastically pressing against the corresponding ones of the battery cells 38. The spring clips 52 may be configured for pre-compressing the battery cells 38 during installation and accommodating ebattery cell 38 expansion during service, optionally with the spring clips 52 have a convex shape configured for flattening in response to expansion of the battery cells 38. The flattening of the spring clips 52 may be seen in FIG. 4 where a side view of a portion of the MUST plate system 40 is illustrated with the battery cells 38 inserted into corresponding battery channels 56 defined between the crossbeams 50.

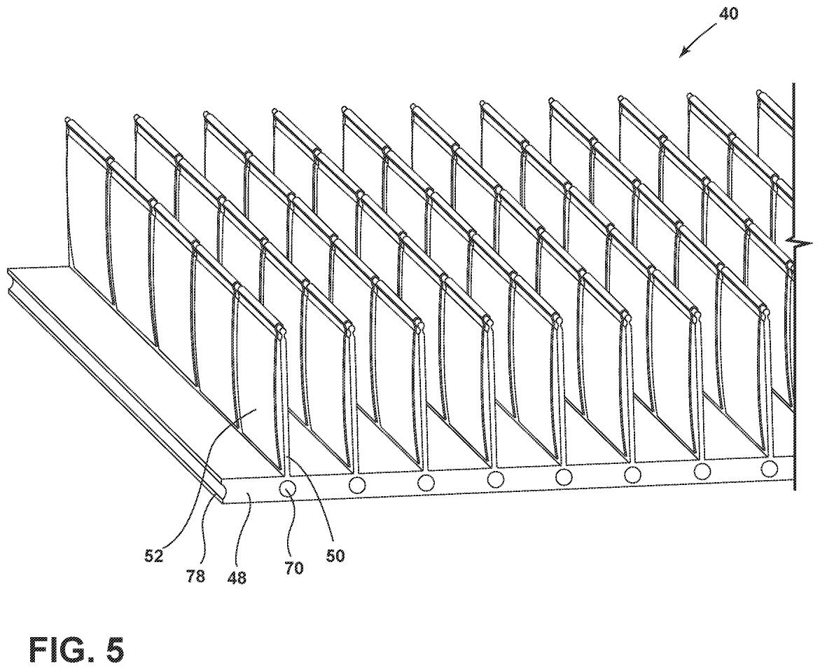

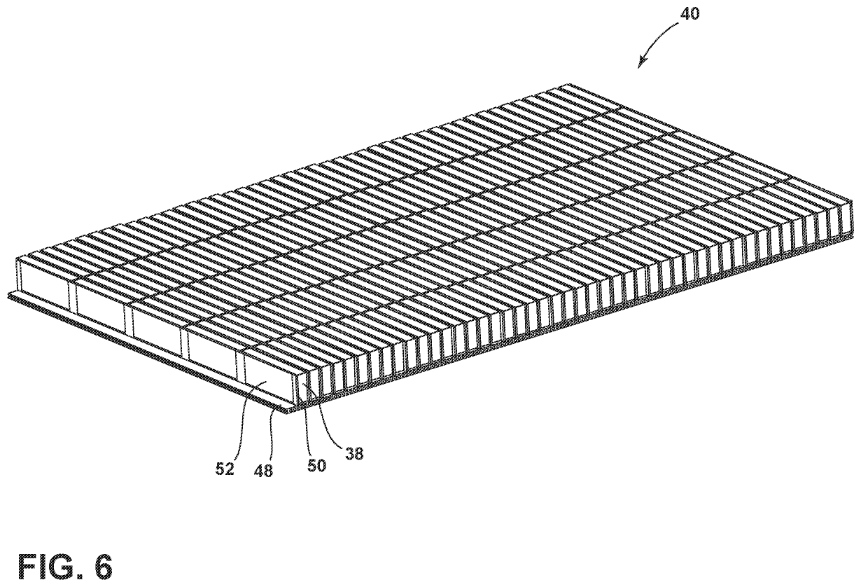

The bottom plate 48 may be shaped relative to a longitudinal axis, a width axis, and a height axis such that the bottom plate 48 includes an upper surface, a lower surface, a front surface, a rear surface, and opposed lateral side surfaces. As shown in FIG. 5, the crossbeams 50 may have a planar shape and be intermittently spaced along the upper surface of the bottom plate 48 relative to the longitudinal axis and shaped to project widthwise across the upper surface relative to the width axis and heightwise upwardly from the upper surface relative to the height axis. The bottom plate 48 and the crossbeams 50 together may form the monolithic, one-piece structure contemplated herein for thermally conducting heat away from and physically supporting the battery cells 38. As shown in FIG. 6, the bottom plate 48 may be configured for supporting a bottom surface of one or more of the battery cells 38. The crossbeams 50 may be configured for supporting a side of one or more of the battery cells 38 placed within the battery channel 56 associated therewith. The crossbeams 50 may extend widthwise across an entirety of the bottom plate 48 such that each crossbeam 50 stretches from one lateral side to the opposed lateral side, which may be useful in sealing off the battery cells 38 in one battery channel 56 from the battery cells 38 in an adjoining battery channel 56.

The present disclosure, however, fully contemplates the crossbeams 50 extending widthwise in a different manner, such as by partially extending widthwise across the bottom plate 48 and/or in different directions, e.g., one or more crossbeams 50 may be perpendicular to the illustrated crossbeams 50 to extend lengthwise along the upper surface from the front surface to the rear surface. Likewise, the crossbeams 50 may extend in the illustrated manner heightwise such that a portion thereof extends above the battery cells 38, which may be useful in facilitating attachment of the lid 36 and/or to further maximize ceiling of one battery channel 56 from another. This is shown for non-limiting purposes as the present disclosure fully contemplates the crossbeams 50 having other heights, including some of the crossbeams 50 having differing heights relative to other crossbeams 50 and/or the same crossbeam 50 having undulations or other height differences from one end to another. The crossbeams 50 may correspond with a wide variety of shapes and configurations capable of being extruded or otherwise formed as a monolithic structure with the bottom plate 48. A thermally conductive material 60 may optionally be applied to the crossbeams 50 to facilitate thermally enhancing heat transfer between the battery cells 38 and the crossbeams 50. The bottom plate 48 may be constructed in a variety of configurations, shapes, dimensions, etc., optionally with portions of the bottom plate 48 having varying dimensions so as to accommodate placement within the vehicle 10 and/or other sizing constraints and requirements.

The battery cells 38 being supported with the MUST plate system 40 are illustrated as a prismatic type of battery cell 38, which may be manufactured to include a flat, rectangular, or square shape, packaged in aluminum, steel, plastic, or laminated pouch or composite case. The battery cells 38, however, may be shaped differently, including being a pouch or can shaped or type of battery cell 38 having rigid or semi-rigid, and in some cases flexible, cases. Particularly when the vehicle 10 is propelled solely by the electric motor 12, the battery pack 30 may include the battery cells 38 arranged into a plurality of battery modules, optionally with the modules and/or battery cells 38 being connected in series and/or parallel with each other. The battery pack 30 may include the battery cells 38 being comprised of a wide variety of materials operable for facilitating the storage and supply of electrical power, and as such, the present disclosure is not intended to be limited to a particular battery material, chemistry, etc. The illustrated battery cells 38 may have a generally consistent shape and size such that the crossbeams 50 may be correspondingly consistent in shape and size, however, the crossbeams 50 may be correspondingly varied to accommodate different sizes, shapes, configurations, etc. for the battery cells 38.

Returning to FIG. 2, the MUST plate system 40 may be tailored to cooperate with the cooling system 42, which may include a cold plate 64, a plurality of conduits 66, a pump and coolant element (not shown) operable to facilitate thermally conducting heat away from the battery cells 38 via coolant pumped through the conduits 66 relative to the bottom plate 48. The cold plate 64 is shown for non-purposes as being adhered to or otherwise in physical contact with the lower surface of the bottom plate 48, such as through brazing. Additional cold plates may be included, such as above the battery cells 38, optionally in place of the lid 36, and/or multiple cold plates may be employed. As shown in greater detail in FIG. 3, the bottom plate 48 may optionally include a plurality of apertures 70 formed below the upper surface within an interior cavity. The apertures 70 may extend throughout the interior cavity to facilitate circulating coolant therethrough for purposes of thermally conducting heat away from the battery cells 38. The bottom plate 48 may alternatively be formed without the apertures 70 as a solid piece of material, optionally with the conduits 66 instead being configured to cycle coolant though the cold plate 64. The MUST plate system 40 or the cooling system 42 may include a pair of sidewalls 72, 74 adhered to opposed lateral sides of the bottom plate 48 and corresponding ones of the crossbeam 50. The sidewalls 72, 74 may be used to seal the ends of the battery channels 56 such that a lower portion of each battery cell 38 channel 56 is sealed relative to the lower portion of the adjoining battery cell 38 channel 56. The sidewalls 72, 74 may include a plurality of through-holes 76 aligned with the apertures 70 formed within the interior cavity of the bottom plate 48 so as to provide openings for the conduits 66 to establish a fluid connection with the apertures 70.

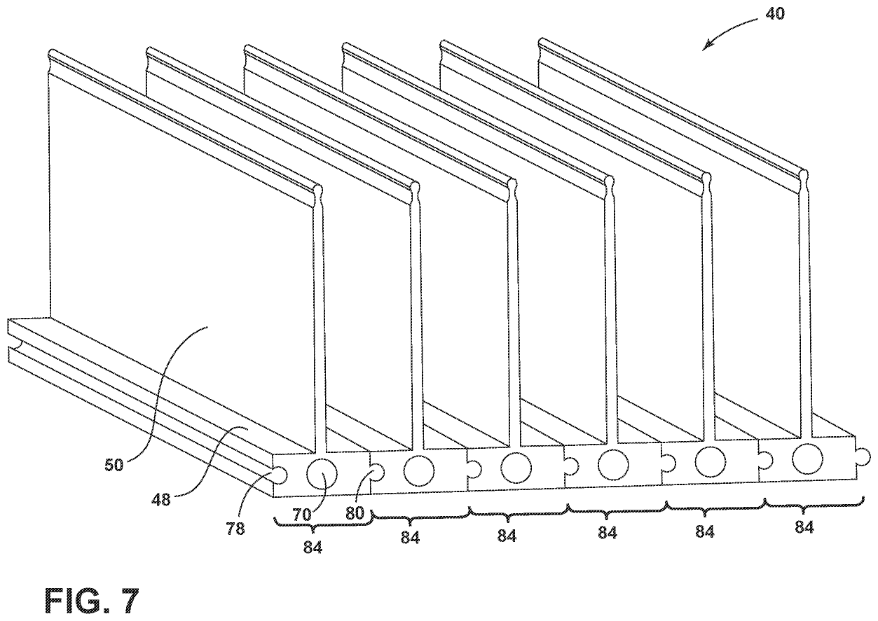

The apertures 70 are shown to extend generally along a similar path as a corresponding one of the crossbeams 50, optionally with the aperture extending widthwise across the bottom plate 48 in an area below the corresponding crossbeam 50. As shown in FIG. 5, the bottom plate 48 may additionally include interlocks 78, 80 at one or more of the front and rear surfaces, i.e., at opposed longitudinal ends of the bottom. The interlocks 78, 80 may be operable for connecting with an interlock of another bottom plate 48 or sidewall of a battery tray (not shown). As shown in FIG. 7, the bottom plate 48 may be divided into segments 84, such as the illustrated manner with one segment 84 being associated with each of the crossbeams 50, with the forward and rear surfaces being shaped to include a corresponding portion of the interlocks 78, 80. The interlocks 78, 80 may be shaped in the illustrated tongue-and-groove manner so as to facilitate connecting portions of the bottom plate 48 together, however, other shapes and configurations may be used without deviating from the scope and contemplation of the present disclosure. The embodiment shown in FIG. 5 may be advantageous from an assembly and manufacturing standpoint due to the bottom plate 48 being larger and thereby requiring less interlocks 78, 80, and the embodiment shown in FIG. 7 may be advantageous from an extrusion process standpoint due the smaller, segments 84 of the bottom plate 48 and the crossbeams 50 being less complex to extrude.

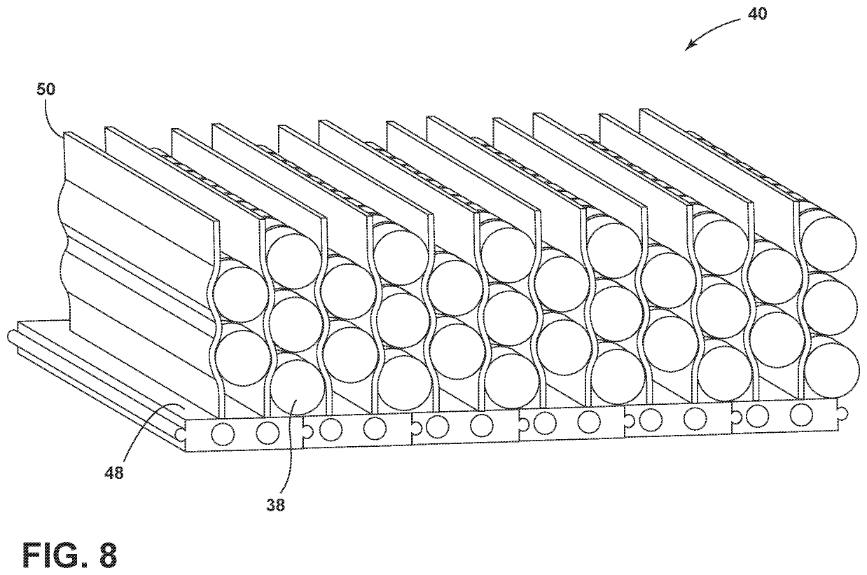

The embodiments described above generally relate to the battery cells 38 being somewhat rectangular in shape such that the battery cells 38 may be dropped into or loaded vertically into the battery channels 56, i.e., by pressing the battery cells 38 into the battery channels 56 from top to bottom relative to the crossbeams 50. FIG. 8 illustrates the crossbeams 50 having a wave or hour-glass shape in accordance with one non-limiting aspect of the present disclosure. The crossbeams 50 may be shaped in the illustrated manner to accommodate the battery cells 38 having a generally cylindrical shape. The cylindrical battery cells 38 may be inserted or loaded horizontally or laterally into the battery channels 56, i.e., by pressing the battery cells 38 into the battery channels 56 from side to side relative to the crossbeams 50. The wave/hour-glass shaping may be provided in the illustrated manner to include narrower portions between vertically separated rows of the battery cells 38. The capability to utilize the crossbeams 50 to offset and separate rows of the battery cells 38 from each other may be beneficial in facilitating electrical interconnections therebetween and/or to provide pathways for air and/or other coolants to pass between the vertically spaced apart battery cells 38.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A multifunctional unified structure thermal plate system for supporting a plurality of battery cells included as part of a high voltage battery pack, comprising:
a bottom plate configured for supporting a bottom surface of one or more of the battery cells, wherein the bottom plate is shaped relative to a longitudinal axis, a width axis, and a height axis;
a plurality of crossbeams configured for supporting a side of one or more of the battery cells, wherein the crossbeams are intermittently spaced along an upper surface of the bottom plate relative to the longitudinal axis and shaped to project widthwise across the upper surface relative to the width axis and heightwise upwardly from the upper surface relative to the height axis; and
wherein the bottom plate and the crossbeams together form a monolithic, one-piece structure operable for thermally conducting heat away from and physically supporting the battery cells.

2. The thermal plate system according to claim 1, wherein:
the bottom plate includes a plurality of apertures formed below the upper surface within an interior cavity, wherein the apertures are operable for circulating coolant to facilitate thermally conducting heat away from the battery cells.

3. The thermal plate system according to claim 1, further comprising:
a plurality of spring clips disposed between corresponding ones of the crossbeams and the battery cells, the spring clips configured for elastically pressing against the corresponding ones of the battery cells.

4. The thermal plate system according to claim 3, wherein:
the spring clips are configured for pre-compressing the battery cells during installation and accommodating cell battery cell expansion during service.

5. The thermal plate system according to claim 4, wherein:
the spring clips have a convex shape configured for flattening in response to expansion of the battery cells corresponding therewith.

6. The thermal plate system according to claim 1, further comprising:
a thermally conductive material applied to the crossbeams, the thermally conductive material operable to facilitate thermally enhancing heat transfer between the battery cells and the crossbeams.

7. The thermal plate system according to claim 1, wherein:
the crossbeams have a substantially planar shape.

8. The thermal plate system according to claim 1, wherein:
the crossbeams have a substantially wave shape.

9. The thermal plate system according to claim 1, wherein:
the crossbeams have a substantially hour-glass shape.

10. The thermal plate system according to claim 1, wherein:
one or more opposed longitudinal ends of the bottom plate are shaped to include an interlock, the interlocks operable for connecting with an interlock of another bottom plate or a sidewall of a battery tray.

11. The thermal plate system according to claim 1, further comprising:
a pair of sidewalls adhered to opposed lateral sides of the bottom plate and corresponding ones of the crossbeams, the sidewalls defining battery cell channels between adjoining one of the corresponding crossbeams.

12. The thermal plate system according to claim 11, wherein:
the sidewalls being adhered to the crossbeams and the bottom plate such that a lower portion of each battery cell channel is sealed relative to the lower portion of the adjoining battery cell channel.

13. The thermal plate system according to claim 12, wherein:
the sidewalls include a plurality of through-holes aligned with a plurality of apertures formed within an interior cavity of the bottom plates.

14. The thermal plate system according to claim 11, further comprising:
a cold plate configured for supporting lower surfaces of the bottom plate and the sidewalls.

15. The thermal plate system according to claim 1, wherein:
the monolithic, one-piece structure is formed as part of an extrusion process.

16. A battery pack for a vehicle, comprising:
a monolithic multifunctional unified structure thermal plate having a plurality of crossbeams intermittently spaced along a bottom plate, the crossbeams shaped to extend widthwise across the bottom plate and upwardly away from the bottom plate; and
a plurality of battery cells disposed between the crossbeams such that a bottom of the battery cells is supported upon the bottom plate and opposed sides of the battery are supported by adjoining pairs of the crossbeams.

17. The battery pack according to claim 16, further comprising:
a plurality of spring clips disposed between the crossbeams and the battery cells, the spring clips having a convex shape configured for elastically pressing against the corresponding ones of the battery cells such that the spring clips pre-compress the battery cells during installation and accommodate cell battery cell expansion during service.

18. The battery pack according to claim 17, wherein:
the bottom plate includes a plurality of apertures formed within an interior cavity, wherein the apertures are operable for circulating coolant to facilitate thermally conducting heat away from the battery cells.

19. A vehicle, comprising:
a monolithic multifunctional unified structure thermal plate having a plurality of crossbeams intermittently spaced along a bottom plate, the crossbeams shaped to extend widthwise across the bottom plate and upwardly away from the bottom plate;
a plurality of battery cells configured for storing and supplying electrical power, wherein the battery cells are disposed between the crossbeams such that a bottom of the battery cells is supported upon the bottom plate and opposed sides of the battery are supported by adjoining pairs of the crossbeams; and
an electric motor operable for generating mechanical power suitable for propelling the vehicle in response to electrical power provided from the battery cells.

20. The vehicle according to claim 19, further comprising:
a plurality of spring clips disposed between the crossbeams and the battery cells, the spring clips having a convex shape configured for elastically pressing against the corresponding ones of the battery cells such that the spring clips pre-compress the battery cells during installation and accommodate cell battery cell expansion during service;
a thermally conductive material applied to the crossbeams, the thermally conductive material operable to facilitate thermally enhancing heat transfer between the battery cells and the crossbeams; and
a coolant system configured for circulating a coolant through a plurality of apertures formed within an interior cavity of the bottom plate, wherein the coolant system includes a cold plate disposed relative to the bottom plate to facilitate dissipating heat from the bottom plate.
